(19) United States
(12) Patent Application Publication
(10) Pub. No.: US 2026/0141465 A1
(43) Pub. Date: May 21, 2026

(54) ENERGY SUPPLY SYSTEM, INFORMATION PROCESSING APPARATUS, INFORMATION PROCESSING METHOD, AND COMPUTER READABLE MEDIUM

(71) Applicant: STEERETAIL CO., LTD., Kawasaki-shi (JP)

(72) Inventors: Keiji Hasegawa, Kawasaki-shi (JP); Hirokazu Shigematsu, Kawasaki-shi (JP); Yuta Yamawaki, Kawasaki-shi (JP); Koichi Watanabe, Kawasaki-shi (JP); Masaaki Hatagawa, Kawasaki-shi (JP); Takuya Funatsu, Kawasaki-shi (JP)

(21) Appl. No.: 19/447,208

(22) Filed: Jan. 13, 2026

Related U.S. Application Data
(62) Division of application No. 18/709,555.

(30) Foreign Application Priority Data
Nov. 30, 2021 (JP) 2021-194272

(51) Int. Cl. G06Q 50/06; G06K 7/14; G06Q 20/32

(52) U.S. Cl. CPC G06Q 50/06; G06Q 20/3276; G06K 7/1417

(57) ABSTRACT

An information processing apparatus includes: an acquisition unit configured to acquire, from the user's terminal, identification information on the user, information on an amount of energy specified by the user, and identification information on the code read by the user's terminal from the display object; a control unit configured to control, based on information in which the identification information on the code is recorded in association with identification information on the supply device, the supply device in accordance with the identification information on the code based on information on an amount of energy specified by the user; and a payment unit configured to make a payment of an amount of money, which corresponds to the amount of energy supplied from the supply device to the user, from a balance of an account of the user.

### RELATED APPLICATION DATA

This application is a Divisional of copending U.S. application Ser. No. 18/709,555 filed on May 15, 2024, and claims priority to National Stage Entry of PCT/JP 2022/018520 filed on Apr. 22, 2022, which claims priority from JP Patent Application 2021-194272 filed on Nov. 30, 2021, the contents of all of which are incorporated herein by reference, in their entirety.

### TECHNICAL FIELD

The present disclosure relates to an energy supply system, an information processing apparatus, an information processing method, and a computer readable medium.

### BACKGROUND ART

Patent Literature 1 discloses a technique for allowing a weighing machine that corresponds to weighing machine identification information transmitted from a customer's terminal obtained by capturing an image of a display object including the weighing machine identification information for identifying the weighing machine installed in a refueling station.

### CITATION LIST

### Patent Literature

[Patent Literature 1] Japanese Unexamined Patent Application Publication No. 2021-041998

### SUMMARY OF INVENTION

### Technical Problem

However, in a technique disclosed in Patent Literature 1 in which the display object includes the weighing machine identification information, there is a problem, for example, that the display object can be manufactured only after it is determined in which weighing machine this display object is to be installed.

The present disclosure has been made in view of the aforementioned problem, and an object of the present disclosure is to provide an energy supply system, an information processing apparatus, an information processing method, and a computer readable medium capable of causing energy to be supplied appropriately.

### Solution to Problem

In a first aspect according to the present disclosure, an energy supply system including:
an information processing apparatus; a supply device that supplies energy; a display object that is installed in association with the supply device and displays a code; and a user's terminal, in which the information processing apparatus includes: an acquisition unit configured to acquire, from the user's terminal, identification information on the user, information on an amount of energy specified by the user, and identification information on the code read by the user's terminal from the display object; a control unit configured to control, based on information in which the identification information on the code is recorded in association with identification information on the supply device, the supply device in accordance with the identification information on the code based on information on an amount of energy specified by the user; and a payment unit configured to make a payment of an amount of money, which corresponds to the amount of energy supplied from the supply device to the user, from a balance of an account of the user is provided.

Further, in a second aspect according to the present disclosure, an information processing apparatus including: an acquisition unit configured to acquire, from a user's terminal, identification information on a user, information on an amount of energy specified by the user, and identification information on a code read by the user's terminal from a display object that is installed in association with a supply device that supplies energy and displays the code; a control unit configured to control, based on information in which the identification information on the code is recorded in association with identification information on the supply device, the supply device in accordance with the identification information on the code based on the information on the amount of energy specified by the user; and a payment unit configured to make a payment of an amount of money, which corresponds to the amount of energy supplied from the supply device to the user, from a balance of an account of the user is provided.

Further, in a third aspect according to the present disclosure, an information processing method executing: processing for acquiring, from a user's terminal, identification information on a user, information on an amount of energy specified by the user, and identification information on a code read from a display object that is installed in association with a supply device that supplies energy and displays the code; processing for controlling, based on information in which the identification information on the code is recorded in association with identification information on the supply device, the supply device in accordance with the identification information on the code based on the information on the amount of energy specified by the user; and processing for making a payment of an amount of money, which corresponds to the amount of energy supplied from the supply device to the user, from a balance of an account of the user is provided.

Further, in a fourth aspect according to the present disclosure, a non-transitory computer readable medium storing a program for causing a computer to execute: processing for acquiring, from a user's terminal, identification information on a user, information on an amount of energy specified by the user, and identification information on a code read from a display object that is installed in association with a supply device that supplies energy and displays the code; processing for controlling, based on information in which the identification information on the code is recorded in association with identification information on the supply device, the supply device in accordance with the identification information on the code based on the information on the amount of energy specified by the user; and processing for making a payment of an amount of money, which corresponds to the amount of energy supplied from the supply device to the user, from a balance of an account of the user is provided.

Further, in a fifth aspect according to the present disclosure, an energy supply system including: an information processing apparatus; a supply device that supplies energy; and a display object that is installed in association with the supply device and displays a code, in which the information processing apparatus includes: an acquisition unit configured to acquire, from a user's terminal, identification information on a user, information on an amount of energy specified by the user, and identification information on the code read by the user's terminal from the display object; a control unit configured to control, based on information in which the identification information on the code is recorded in association with identification information on the supply device, the supply device in accordance with the identification information on the code based on information on an amount of energy specified by the user; and a payment unit configured to make a payment of an amount of money, which corresponds to the amount of energy supplied from the supply device to the user, from a balance of an account of the user is provided.

### Advantageous Effects of Invention

According to one aspect, it is possible to cause energy to be supplied appropriately.

### BRIEF DESCRIPTION OF DRAWINGS

FIG. 1 is a diagram showing one example of a configuration of an information processing apparatus according to an example embodiment;

FIG. 2 is a diagram showing a configuration example of an energy supply system according to the example embodiment;

FIG. 3 is a diagram showing a hardware configuration example of the information processing apparatus according to the example embodiment;

FIG. 4 is a sequence diagram showing one example of a process of the energy supply system according to the example embodiment;

FIG. 5 is a diagram showing one example of a code DB according to the example embodiment; and

FIG. 6 is a diagram showing one example of a unit cost DB according to the example embodiment.

### EXAMPLE EMBODIMENT

Principles of the present disclosure are described with reference to several example embodiments. It should be understood that these example embodiments are set forth for purposes of illustration only and that those skilled in the art will assist in understanding and practicing the present disclosure without suggesting limitations on the scope of the present disclosure. The disclosure described herein may be implemented in various methods other than those described below.

In the following description and claims, unless otherwise defined, all technical and scientific terms used herein have the same meaning as commonly understood by one of those skilled in the art of technology to which the present disclosure belongs.

Hereinafter, example embodiments of the present disclosure will be described with reference to the drawings.

### First Example Embodiment

### <Configuration>

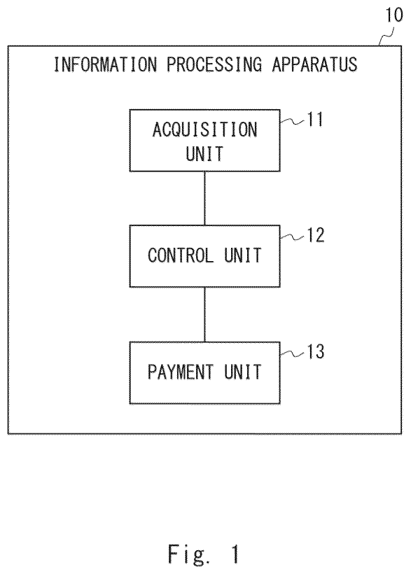

With reference to FIG. 1, a configuration of an information processing apparatus 10 according to an example embodiment will be described. FIG. 1 is a diagram showing one example of the configuration of the information processing apparatus 10 according to the example embodiment. The information processing apparatus 10 includes an acquisition unit 11, a control unit 12, and a payment unit 13. These units may be implemented by cooperation of one or more programs installed in the information processing apparatus 10 and hardware such as a processor 101, a memory 102, and so on of the information processing apparatus 10.

The acquisition unit 11 acquires various kinds of information from a storage unit inside the information processing apparatus 10, and an external device. The acquisition unit 11 acquires, for example, identification information on the user from a user's terminal. Further, the acquisition unit 11 acquires, for example, information on an amount of energy to be supplied to a user's article, which the information has been specified by the user, from the user's terminal. Further, the acquisition unit 11 acquires, for example, from the user's terminal, identification information on a code read by a user's terminal from a display object that is installed in association with a supply device that supplies energy and displays a code.

The control unit 12 performs various kinds of processes based on information and the like acquired by the acquisition unit 11. The control unit 12 controls, for example, a supply device in accordance with the identification information on the code acquired from the acquisition unit 11 based on information on the amount of energy specified by the user. In this case, the control unit 12 may control, for example, based on information in which the identification information on the code is recorded in association with identification information on the supply device, the supply device in accordance with the identification information on the code acquired from the acquisition unit 11 based on the information on the amount of energy specified by the user.

The payment unit 13 makes a payment according to an instruction from the control unit 12. The payment unit 13 makes a payment, for example, of an amount of money in accordance with the amount of energy supplied from the supply device to the user's article from a balance of an account of the user.

### Second Example Embodiment

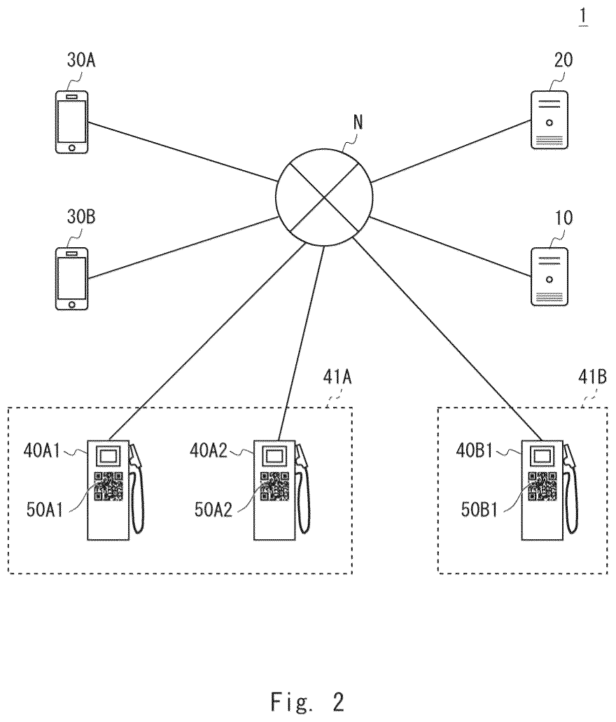

Next, with reference to FIG. 2, a configuration of an energy supply system 1 according to the example embodiment will be described.

### <System Configuration>

FIG. 2 is a diagram showing a configuration example of the energy supply system 1 according to the example embodiment. In the example shown in FIG. 2, the energy supply system 1 includes an information processing apparatus 10 and a payment server 20. Further, the energy supply system 1 includes a user terminal 30A, a user terminal 30B, . . . (when there is no need to distinguish between them, they may be simply referred to as a “user terminal 30”). Further, the energy supply system 1 includes a supply device 40A1, a supply device 40A2, . . . , installed in a facility 41A, a supply device 40B1 installed in a facility 41B, . . . (when there is no need to distinguish between them, they may be simply referred to as a “supply device 40”). Further, the supply device 40A1, the supply device 40A2, . . . , the supply device 40B1, . . . respectively include a display object 50A1, a display object 50A2, . . . , a display object 50B1, . . . (when there is no need to distinguish between them, they may be simply referred to as a “display object 50”). The number of information processing apparatuses 10, the number of payment servers 20, the number of user terminals 30, the number of supply devices 40, and the number of display objects 50 are not limited to those shown in the example in FIG. 2.

In the example shown in FIG. 2, the information processing apparatus 10, the payment server 20, the user terminal 30, and the supply device 40 are connected to one another in such a way that they can communicate with one another via a network N. Examples of the network N include, for example, the Internet, a mobile communication system, wireless Local Area Network (LAN), LAN, and a bus. Examples of the mobile communication system include, for example, the fifth generation mobile communication system (5G), the fourth generation mobile communication system (4G), and the third generation mobile communication system (3G).

The information processing apparatus 10 is, for example, an apparatus such as a server, a cloud, a personal computer, or a smartphone. The information processing apparatus 10 provides, for example, various services such as energy supply for the user. The payment server 20 is, for example, a server of a provider who provides a cashless payment service. The payment server 20 pays (settles or collects), for example, the fee from the balance of the user's account for cashless payment (hereinafter it will be referred to as a “user's account” as well). Note that the user's account for cashless payment may include, for example, a credit card account, an account for code (e.g., a two-dimensional code or a barcode) payment, or a user's bank account. Further, the balance of the account may include the balance of a usage limit amount (credit) of a credit card or the like (e.g., an amount of money obtained by subtracting the used amount from the usage limit amount), an amount of money received from the bank account, an amount of money received from an Automatic Teller Machine (ATM), an amount of money deposited through personal remittance, points, etc.

The user terminal 30 is, for example, a terminal such as a smartphone, a tablet, a mobile terminal, a portable terminal, or a wearable device. Note that the wearable device may include, for example, a smartwatch and smart glasses. The user terminal 30 is used by a user who uses various services such as energy supply.

The supply device 40 is a device that supplies energy according to an instruction from the information processing apparatus 10. The “energy” according to the present disclosure may include, for example, gasoline (including high-octane, and regular), light oil, hydrogen, electricity or the like. When the supply device 40 supplies gasoline, this supply device 40 may be referred to as a weighing machine, a gasoline weighing machine or the like. When the supply device 40 supplies hydrogen, this supply device 40 may be referred to as a hydrogen dispenser or the like. When the supply device 40 supplies electricity, this supply device 40 may be referred to as, for example, a charger with a weighing machine.

When the supply device 40 supplies gasoline, the facility 41A or the like where this supply device 40 is installed may be referred to as a gas station or the like. When the supply device 40 supplies hydrogen, the facility 41A or the like where this supply device 40 is installed may be referred to as a hydrogen station or the like. When the supply device 40 supplies electricity, the facility 41A or the like where this supply device 40 is installed may be referred to as a charging spot or the like. The supply device 40 supplies energy to the user's article. This article may include, for example, a vehicle, an electric Vertical Takeoff and Landing aircraft (eVTOL), a drone, a tank (e.g., a polyethylene tank or a can), a battery, or the like.

The display object 50 is, for example, a display object such as a seal, a paper (POP), a poster or the like with a code printed on it. The code is a figure or the like indicating a code ID that uniquely identifies the code. Examples of the “code” according to the present disclosure may include, for example, a two-dimensional code such as a Quick Response (QR) code (registered trademark), a code such as a barcode, etc.

### <Hardware Configuration of Information Processing Apparatus 10>

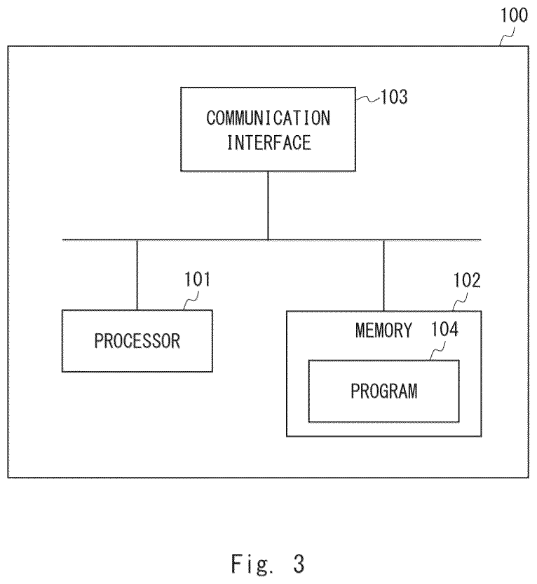

FIG. 3 is a diagram showing a hardware configuration example of the information processing apparatus 10 according to the example embodiment. In the example shown in FIG. 3, the information processing apparatus 10 (a computer 100) includes a processor 101, a memory 102, and a communication interface 103. These components may be connected to each other by a bus or the like. The memory 102 stores at least a part of the program 104. The communication interface 103 includes an interface needed to communicate with other network elements.

When the program 104 is executed by cooperation of the processor 101, the memory 102, etc., the computer 100 performs at least a part of the processes of the example embodiments of the present disclosure. The memory 102 may be of any type suitable for a local technology network. The memory 102 may be, as a non-limiting example, a non-transitory computer-readable storage medium. Also, the memory 102 may be implemented using any suitable data storage technology, such as a semiconductor-based memory device, a magnetic memory device and system, an optical memory device and system, a fixed and removable memory, and the like. Although only one memory 102 is shown in the computer 100, there may be several physically different memory modules in the computer 100. The processor 101 may be of any type. The processor 101 may include one or more of a general purpose computer, a special purpose computer, a microprocessor, a digital signal processor (DSP), and a processor based on a multi-core processor architecture as a non-limiting example. The computer 100 may include a plurality of processors, such as an application specific integrated circuit chip that is temporally dependent on a clock that synchronizes the main processor.

The example embodiments of the present disclosure may be implemented in hardware or dedicated circuit, software, logic, or any combination thereof. Some modes may be implemented in hardware, while other modes may be implemented in firmware or software, which may be executed by a controller, a microprocessor or other computing devices.

The present disclosure also provides at least one computer program product tangibly stored in a non-transitory computer-readable storage medium. The computer program product includes computer-executable instructions, such as instructions included in program modules, to be executed on a device on a target real or virtual processor to perform the processes or the method of the present disclosure. The program modules include routines, programs, libraries, objects, classes, components, data structures, etc. that perform specific tasks or implement specific abstract data types. The functionality of the program modules may be combined or split between program modules as desired in various example embodiments. Machine-executable instructions for program modules may be executed in a local or a distributed device. In a distributed device, program modules can be located in both local and remote storage media.

Program code for executing the method of the present disclosure may be written in any combination of one or more programming languages. The program code is provided to a processor or a controller of a general purpose computer, a special purpose computer, or other programmable data processing devices. When the program code is executed by the processor or the controller, the functions/operations in the flowchart and/or an implemented block diagram are performed. The program code is executed entirely on a machine, as a stand-alone software package, partly on a machine, partly on a remote machine, or entirely on a remote machine or a server.

The program can be stored using various types of non-transitory computer-readable media and provided to the computer. The non-transitory computer-readable media include various types of tangible recording media. Examples of the non-transitory computer-readable media include magnetic recording media, magneto-optical recording media, optical disc media, semiconductor memories, and the like. The magnetic recording media include, for example, a flexible disk, a magnetic tape, a hard disk drive, and the like. The magneto-optical recording media include, for example, a magneto-optical disk and the like. The optical disc media include, for example, a Blu-ray disc, a compact disc read-only memory (CD-ROM), a compact disc recordable (CD-R), a compact disc rewritable (CD-RW), and the like. The semiconductor memories include, for example, a solid state drive, a mask ROM, a programmable ROM (PROM), an erasable PROM (EPROM), a flash ROM, a random access memory (RAM), and the like. The program may also be provided to the computer by various types of transitory computer-readable media. Examples of the transitory computer-readable media include an electrical signal, an optical signal, and an electromagnetic wave. The transitory computer-readable media can provide the program to the computer via a wired communication path, such as an electric wire and an optical fiber, or a wireless communication path.

### <Processes>

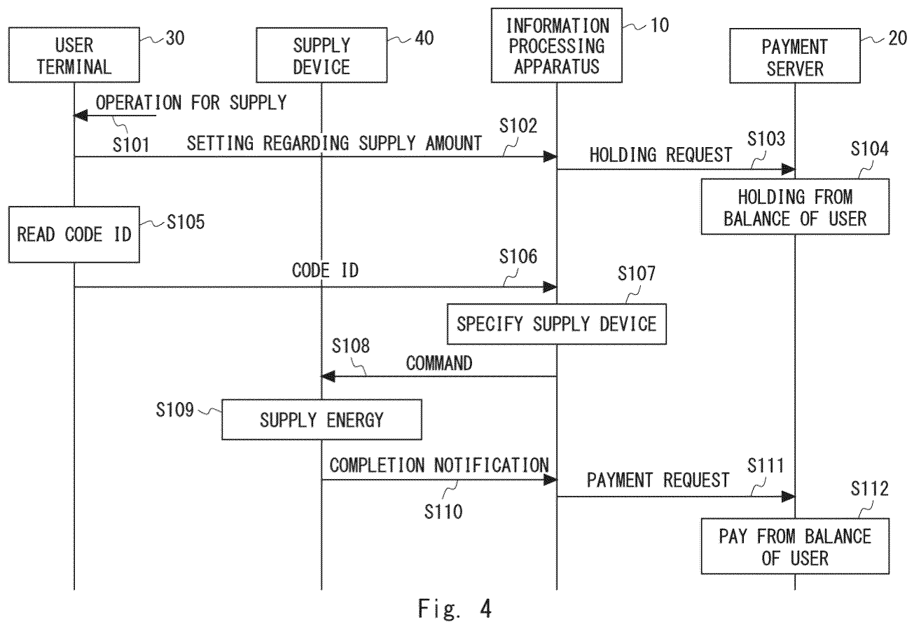

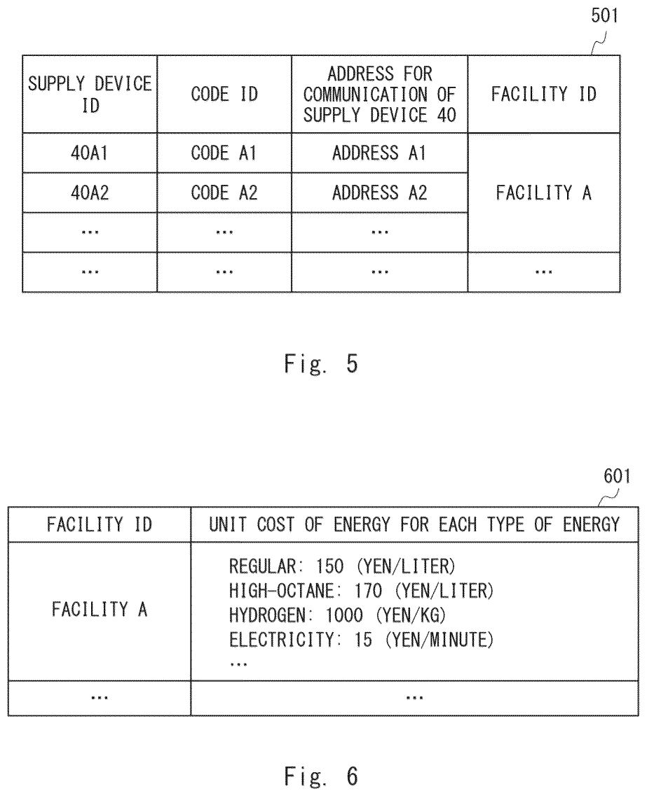

Referring next to FIGS. 4 to 6, one example of the process of the energy supply system 1 according to the example embodiment will be described. FIG. 4 is a sequence diagram showing one example of the process of the energy supply system 1 according to the example embodiment. FIG. 5 is a diagram showing one example of a code database (DB) 501 according to the example embodiment. FIG. 6 is a diagram showing one example of a unit cost DB 601 according to the example embodiment.

It is assumed, in the following, that the user terminal 30 is authenticated by (logs in to) the information processing apparatus 10 using information for authentication such as a user ID, a password, and so on. It is further assumed that the communication data transmitted from the user terminal 30 to the information processing apparatus 10 includes information indicating the user ID of the user of the user terminal 30. In this case, the communication between the user terminal 30 and the information processing apparatus 10 may be encoded, for example, using Hypertext Transfer Protocol Secure (HTTPS) or the like. The information processing apparatus 10 may store, for example, the session ID generated when the user terminal 30 logs in to the information processing apparatus 10 and the user ID in association with each other. Further, the communication between the user terminal 30 and the information processing apparatus 10 may include information on the session ID. Accordingly, the information processing apparatus 10 may associate the information received from the user terminal 30 with the user ID.

Further, the communication between the information processing apparatus 10 and the supply device 40 may be encoded by Security Architecture for IP (IPSec)-Virtual Private Network (VPN), Secure Socket Layer (SSL)-VPN or the like. The information processing apparatus 10 may identify, for example, each supply device 40 by using an address for communication of each supply device 40.

In Step S101, the user terminal 30 receives an operation for receiving energy supply from the user. Note that the user terminal 30 may receive, for example, input of setting of information on the amount of energy (hereinafter it will be also referred to as “setting of the supply method” as well) from the user on a display screen of a Web browser or an application. The setting of the supply method may include, for example, information indicating one of a setting for receiving supply of an amount of energy that is equal to or less than the amount of money specified by the user (hereinafter, it will be also referred to as “specification of the amount of money” as well), a setting for receiving supply of an amount of energy which is equal to or less than the amount of energy specified by the user (hereinafter it will be referred to as “specification of the amount of energy” as well), or a setting for receiving supply of an upper-limit amount of the energy that can be supplied at one time to the user's article (i.e., a full tank) (hereinafter it will be referred to as “specification of a full tank” as well). Further, the setting of the supply method may include, for example, the type of the energy to be supplied (e.g., high-octane, regular, light oil, hydrogen, or power). The amount of money when the amount of money is specified, the amount of energy when the amount of energy is specified, and a full tank when a full tank is specified are examples of “information on the amount of energy”.

Next, the user terminal 30 transmits information indicating the setting of the supply method specified by the user to the information processing apparatus 10 (Step S102). Next, the payment unit 13 of the information processing apparatus 10 transmits a request for holding the amount of money in accordance with the setting of the supply method to the payment server 20 (Step S103). When, for example, the setting of the supply method is the specification of the amount of money, the payment unit 13 of the information processing apparatus 10 may transmit a request for holding the amount of money specified by the user (e.g., 3000 yen). Further, when, for example, the setting of the supply method is the specification of the amount of energy, the payment unit 13 of the information processing apparatus 10 may transmit a request for holding an amount of money in accordance with the amount of energy specified by the user (e.g., an amount of money obtained by multiplying the amount of energy by a specified amount of money). Further, when, for example, the setting of the supply method is the specification of a full tank, the payment unit 13 of the information processing apparatus 10 may transmit a request for holding a specified amount of money (e.g., 7,000 yen). The specified amount of money may be set in the information processing apparatus 10 in advance.

Next, the payment server 20 sets this amount of money for holding (i.e., unavailable, reserved, or secured) from the balance of the account of the user (Step S104). The payment server 20 sets that the balance corresponding to the amount of money that is set to be held cannot be used for payment of fees for products or services other than payment of fee for the energy supplied using the information processing apparatus 10. That is, the balance corresponding to the amount of money that is held cannot be used for payment for purposes other than for the payment of fee for the energy supplied using the information processing unit 10. It is therefore possible to reduce, for example, a situation arising where the user cannot pay the fee due to a lack of a balance after the energy has been supplied at a gas station, a hydrogen station, a charging spot or the like which is, for example, a self-service place.

The payment server 20 may transmit a notification indicating that the above amount of money has been held to the user terminal 30. Accordingly, the user can know, for example, how much of his/her balance has been held and how much of his/her balance has not been held. When the balance of the account of the user is smaller than the amount of money that is requested to be held by the information processing apparatus 10, the payment server 20 may send a notification indicating this situation to the user terminal 30 via the information processing apparatus 10. It is therefore possible for the user to change, for example, the amount of money or the like and perform the input operation in Step S101 again.

Next, the user terminal 30 reads the identification information on the code (code ID) from the display object 50 (Step S105). Here, the user captures an image of the display object 50 installed in association with the supply device 40 by the user terminal 30. Then, the user terminal 30 decodes the code ID of the display object 50 based on the captured image.

Next, the user terminal 30 transmits the code ID to the information processing apparatus 10 (Step S106). Next, the control unit 12 of the information processing apparatus 10 specifies the supply device 40 in accordance with the code ID (Step S107). Here, the control unit 12 of the information processing apparatus 10 may refer to, for example, the supply device DB 501 and acquire information on the supply device 40 associated with the code ID. In the example shown in FIG. 5, the code ID, the address for communication of the supply device 40 (e.g., IP address), and a facility ID are registered in the code DB 501 in such a way that they are associated with the ID (supply device ID) of the supply device 40. The supply device ID may be, for example, a manufacturer's serial number or the like of the supply device 40. The facility ID is identification information on the facility in which the supply device 40 is installed (e.g., the facility 41A). The facility ID may be, for example, the name or the like of the shop. Note that the code DB 501 may be recorded in a storage device inside the information processing apparatus 10 or may be recorded in a DB server or the like which is located outside the information processing apparatus 10.

The address (e.g., IP address) for communication of the supply device 40 may be registered in the code DB 501 in such a way that this address is associated with each supply device ID by an operator (an administrator) or the like in advance. Further, a unique code ID may be determined for each display object 50. Then, a code obtained by encoding the code ID may be printed on the display object 50. When the display object 50 is installed in association with the supply device 40 by a worker or the like, the code ID of the display object 50 may be registered in association with the supply device ID of the supply device 40 by the worker or the like. Note that the supply device ID may be printed, for example, on a seal or the like stuck to the supply device 40.

When, for example, a code obtained by encoding information including the supply device ID and the like is printed on the display object 50, the display object 50 in accordance with each supply device 40 used in the energy supply system 1 needs to be manufactured after the contract between the energy supplier and the system operator is made. Therefore, for example, the time (lead time) from order (contract) to delivery (system introduction) becomes relatively large. Further, when the unit of the order (contract) is relatively small (e.g., one facility (one shop)), the cost for manufacturing the display object 50 may increase.

On the other hand, according to the present disclosure, it is possible to print (manufacture) a specific number of display objects 50 before the contract is made. It is therefore possible to reduce, for example, the lead time and the cost for manufacturing the display object 50.

Next, the control unit 12 of the information processing apparatus 10 transmits a command for instructing supply of the energy to the specified supply device 40 (Step S108). This command may include information indicating the setting of the supply method and information in accordance with the amount of money held in the process of Step S103.

Examples of the information in accordance with the amount of money held in the process of Step S103 may include, for example, information indicating the amount of money held in the process of Step S103 or information indicating the amount of energy that can be supplied with this amount of money. Note that the amount of energy that can be supplied with this amount of money may be, for example, an amount of the value obtained by dividing this amount of money by the unit cost of the energy of the type specified by the user. In this case, the control unit 12 of the information processing apparatus 10 may refer to the unit cost DB 601 to acquire information on the unit cost in accordance with the facility in which the supply device 40 is installed. In the example shown in FIG. 6, the unit cost of the energy for each type of the energy is registered in the unit cost DB 601 in advance in such a way that the unit cost of the energy is associated with the facility ID. Note that the unit cost DB 601 may be recorded in a storage device inside the information processing apparatus 10 or may be recorded in a DB server or the like which is located in the outside of the information processing apparatus 10.

When, for example, the amount of money that is held is 7,000 yen and the unit cost of the energy of the type specified by the user is 150 yen per liter, the control unit 12 of the information processing apparatus 10 may calculate the amount of energy that can be supplied with this amount of money to be 46.67(≈7,000/150) liters.

Next, the supply device 40 supplies energy based on the received command (Step S109). Here, when the setting of the supply method specified by the user is the specification of the amount of money, the supply device 40 supplies an amount of energy that corresponds to the specified amount of money if the amount of energy supplied does not reach the upper-limit amount that can be supplied at one time while the energy is being supplied. Further, the supply is stopped (completed) when the amount of energy supplied has reached the upper-limit amount that can be supplied at one time while the energy is being supplied.

Further, when the setting of the supply method specified by the user is the specification of a full tank, the supply device 40 supplies the maximum amount of energy that can be supplied at one time if the amount of energy supplied does not reach the amount of energy that corresponds to the amount of money held in the process of Step S103 while the energy is being supplied. Further, when the amount of energy supplied reaches the amount of energy that corresponds to the amount of money held in the process of Step S103 while the energy is being supplied, the supply is stopped (completed) at the timing when the amount of energy supplied reaches the amount of energy that corresponds to the amount of money held. That is, for example, it is possible to reduce a situation arising where the user cannot pay the fee due to a lack of a balance after the energy has been supplied at a gas station, a hydrogen station, a charging spot or the like which is, for example, a self-service place.

Next, the supply device 40 transmits a notification indicating that energy supply has been completed to the information processing apparatus 10 (Step S110). This notification may include information indicating the amount of energy supplied for the user.

Next, the payment unit 13 of the information processing apparatus 10 transmits a request for paying for the energy supplied by the supply device 40 to the payment server 20 (Step S111). Here, the payment unit 13 of the information processing apparatus 10 may calculate the fee based on the amount of energy for which the notification has been sent from the supply device 40 and the unit cost of this energy. Accordingly, when, for example, the user has specified the supply method for supplying energy by specifying the amount of money, 3,000 yen, but the tank is filled while the energy is being supplied, and the amount of energy that corresponds to 2,700 yen at the unit cost is eventually supplied in accordance with the supply device 40, the fee can be determined to be 2,700 yen.

Next, the payment server 20 makes the payment from the balance of the account of the user of the user terminal 30 (Step S112). Here, the payment server 20 may subtract, for example, the fee from the balance of the account of the user. Then, the payment server 20 may add (remit), for example, an amount of electric money that corresponds to the fee to the account of the provider of the information processing apparatus 10.

### Example of Checking Supply Device 40 by Issuing First Authentication Code to User Terminal 30

The information processing apparatus 10 may check the supply device 40 by issuing an authentication code to the user terminal 30 and causing the user to enter this authentication code into the supply device 40. Accordingly, even when, for example, a display object 50 installed in association with a supply device 40 is copied (duplicated) and is installed in association with another supply device 40 intentionally or negligently, it is possible to prevent energy from being provided for articles of other users.

In the above case, the control unit 12 of the information processing apparatus 10 may generate, in the process of Step S107 in FIG. 4, an authentication code such as a one-time password and transmit the generated authentication code to the user terminal 30. Note that the authentication code may be, for example, a number with a predetermined number of digits (e.g., four digits).

Then, the supply device 40 may receive the authentication code from the user of the user terminal 30 by an operation of a numeric keypad or the like. Then, the supply device 40 may transmit the authentication code input by the user to the information processing apparatus 10. Then, the control unit 12 of the information processing apparatus 10 may determine whether or not the generated authentication code matches the authentication code received by the supply device 40. Then, the control unit 12 of the information processing apparatus 10 may determine whether or not the supply device 40 specified based on the code ID in the process of Step S107 in FIG. 4 matches the supply device 40 that has transmitted the authentication code only when the above authentication codes match each other. Then, the control unit 12 of the information processing apparatus 10 may cause the supply device 40 to execute the process of Step S108 and the following processes in FIG. 4 only when the above supply devices 40 match each other.

### Example of Checking User Terminal 30 by Issuing Second Authentication Code to Supply Device 40

The information processing apparatus 10 may check the user terminal 30 by issuing an authentication code for the supply device 40 and causing the user to enter the authentication code into the user terminal 30. Accordingly, even when, for example, a display object 50 installed in association with a supply device 40 is copied (duplicated) and is installed in association with another supply device 40 intentionally or negligently, it is possible to prevent energy from being provided for articles of other users

In this case, the control unit 12 of the information processing apparatus 10 may generate, in the process of Step S107 in FIG. 4, an authentication code such as a one-time password and transmit the generated authentication code to the supply device 40. Note that the authentication code may be, for example, a number with a predetermined number of digits (e.g., four digits).

Then, the supply device 40 may cause a display device to display the received authentication code. Then, the user terminal 30 may receive the authentication code that is input by the user. Then, the user terminal 30 may transmit the authentication code input by the user to the information processing apparatus 10. Then, the control unit 12 of the information processing apparatus 10 may determine whether the generated authentication code matches the authentication code received from the user terminal 30. Then, the control unit 12 of the information processing apparatus 10 may determine whether or not the user terminal 30 that has transmitted the code ID in the process of Step S106 in FIG. 4 matches the user terminal 30 that has transmitted the authentication code only when the above authentication codes match each other. Then, the control unit 12 of the information processing apparatus 10 may cause the supply device 40 to execute the process of Step S108 and the following processes in FIG. 4 only when the above user terminals 30 match each other.

### Modified Examples

While the information processing apparatus 10 may be an apparatus that is included in one housing, the information processing apparatus 10 according to the present disclosure is not limited to it. Each part of the information processing apparatus 10 may be implemented, for example, by cloud computing formed of one or more computers. Further, the information processing apparatus 10 and the supply device 40 may be accommodated in one housing and may be configured as an integrated information processing apparatus. Further, at least a part of the process of each functional unit of the information processing apparatus 10 may be executed by at least one of the supply device 40 or the user terminal 30. This kind of information processing apparatus 10 is also included in one example of the “information processing apparatus” of the present disclosure.

Note that the present invention is not limited to the above example embodiments and may be changed as appropriate without departing from the spirit of the present invention.

The whole or part of the exemplary embodiments disclosed above can be described as, but not limited to, the following supplementary notes.

### (Supplementary Note 1)

An energy supply system comprising:
an information processing apparatus; a supply device that supplies energy; a display object that is installed in association with the supply device and displays a code; and a user's terminal, wherein
the information processing apparatus comprises:
an acquisition unit configured to acquire, from the user's terminal, identification information on the user, information on an amount of energy specified by the user, and identification information on the code read by the user's terminal from the display object;
a control unit configured to control, based on information in which the identification information on the code is recorded in association with identification information on the supply device, the supply device in accordance with the identification information on the code based on information on an amount of energy specified by the user; and
a payment unit configured to make a payment of an amount of money, which corresponds to the amount of energy supplied from the supply device to the user, from a balance of an account of the user.

### (Supplementary Note 2)

The energy supply system according to Supplementary Note 1, wherein
the payment unit specifies a unit cost of the energy to be supplied from the supply device to the user based on the identification information on the code, and sets, when the user has specified that a maximum amount of energy that can be supplied at one time to the user's article is to be supplied, that the specified amount of money cannot be used from the balance of the account of the user, and
the control unit controls the supply device to supply an amount of energy which is equal to or less than the amount in accordance with the specified amount of money and the unit cost to the user.

### (Supplementary Note 3)

The energy supply system according to Supplementary Note 1 or 2, wherein
the payment unit specifies a unit cost of the energy to be supplied from the supply device to the user based on the identification information on the code, and sets, when the user has specified that an amount of energy that corresponds to a specified amount of money is to be supplied, that the specified amount of money cannot be used from the balance of the account of the user, and
the control unit controls the supply device to supply an amount of energy which is equal to or less than an amount in accordance with the specified amount of money and the unit cost to the user.

### (Supplementary Note 4)

The energy supply system according to any one of Supplementary Notes 1 to 3, wherein
the payment unit specifies a unit cost of the energy to be supplied from the supply device to the user based on the identification information on the code, and sets, when the user has specified that a specified amount of energy is to be supplied, that a first amount of money in accordance with the specified amount cannot be used from the balance of the account of the user, and
the control unit controls the supply device in such a way that the supply device supplies an amount of energy which is equal to or less than the amount in accordance with the first amount of money and the unit cost to the user.

### (Supplementary Note 5)

The energy supply system according to any one of Supplementary Notes 1 to 4, wherein the control unit transmits a first authentication code to the user's terminal, and controls, when the first authentication code has been input to the supply device, the supply device to supply energy to the user.

### (Supplementary Note 6)

The energy supply system according to any one of Supplementary Notes 1 to 5, wherein the control unit transmits a second authentication code to the supply device, and controls, when the second authentication code has been input to the user's terminal, the supply device to supply energy to the user.

### (Supplementary Note 7)

An information processing apparatus comprising:
an acquisition unit configured to acquire, from a user's terminal, identification information on a user, information on an amount of energy specified by the user, and identification information on a code read by the user's terminal from a display object that is installed in association with a supply device that supplies energy and displays the code;
a control unit configured to control, based on information in which the identification information on the code is recorded in association with identification information on the supply device, the supply device in accordance with the identification information on the code based on the information on the amount of energy specified by the user; and
a payment unit configured to make a payment of an amount of money, which corresponds to the amount of energy supplied from the supply device to the user, from a balance of an account of the user.

### (Supplementary Note 8)

An information processing method executing:
processing for acquiring, from a user's terminal, identification information on a user, information on an amount of energy specified by the user, and identification information on a code read from a display object that is installed in association with a supply device that supplies energy and displays the code;
processing for controlling, based on information in which the identification information on the code is recorded in association with identification information on the supply device, the supply device in accordance with the identification information on the code based on the information on the amount of energy specified by the user; and
processing for making a payment of an amount of money, which corresponds to the amount of energy supplied from the supply device to the user, from a balance of an account of the user.

### (Supplementary Note 9)

A non-transitory computer readable medium storing a program for causing a computer to execute:
processing for acquiring, from a user's terminal, identification information on a user, information on an amount of energy specified by the user, and identification information on a code read from a display object that is installed in association with a supply device that supplies energy and displays the code;
processing for controlling, based on information in which the identification information on the code is recorded in association with identification information on the supply device, the supply device in accordance with the identification information on the code based on the information on the amount of energy specified by the user; and
processing for making a payment of an amount of money, which corresponds to the amount of energy supplied from the supply device to the user, from a balance of an account of the user.

### (Supplementary Note 10)

An energy supply system comprising:
an information processing apparatus; a supply device that supplies energy; and a display object that is installed in association with the supply device and displays a code, wherein
the information processing apparatus comprises:
an acquisition unit configured to acquire, from a user's terminal, identification information on a user, information on an amount of energy specified by the user, and identification information on the code read by the user's terminal from the display object;
a control unit configured to control, based on information in which the identification information on the code is recorded in association with identification information on the supply device, the supply device in accordance with the identification information on the code based on information on an amount of energy specified by the user; and
a payment unit configured to make a payment of an amount of money, which corresponds to the amount of energy supplied from the supply device to the user, from a balance of an account of the user.

This application is based upon and claims the benefit of priority from Japanese patent application No. 2021-194272, filed on Nov. 30, 2021, the disclosure of which is incorporated herein in its entirety by reference.

### REFERENCE SIGNS LIST

1 ENERGY SUPPLY SYSTEM
10 INFORMATION PROCESSING APPARATUS
11 ACQUISITION UNIT
12 CONTROL UNIT
13 PAYMENT UNIT
20 PAYMENT SERVER
30 USER TERMINAL
40 SUPPLY DEVICE
50 DISPLAY OBJECT

1. An information processing apparatus comprising:
at least one memory storing instructions, and
at least one processor configured to execute the instructions to;
acquire, from a user's terminal, identification information on a user, information on an amount of energy specified by the user, and identification information on a code read by the user's terminal from a display object that is installed in association with a supply device that supplies energy and displays the code;
control, based on information in which the identification information on the code is recorded in association with identification information on the supply device, the supply device in accordance with the identification information on the code based on the information on the amount of energy specified by the user; and
make a payment of an amount of money, which corresponds to the amount of energy supplied from the supply device to the user, from a balance of an account of the user.

2. An information processing method executing:
processing for acquiring, from a user's terminal, identification information on a user, information on an amount of energy specified by the user, and identification information on a code read from a display object that is installed in association with a supply device that supplies energy and displays the code;
processing for controlling, based on information in which the identification information on the code is recorded in association with identification information on the supply device, the supply device in accordance with the identification information on the code based on the information on the amount of energy specified by the user; and
processing for making a payment of an amount of money, which corresponds to the amount of energy supplied from the supply device to the user, from a balance of an account of the user.
